(19) United States
(12) Patent Application Publication
(10) Pub. No.: US 2023/0269607 A1
(43) Pub. Date: Aug. 24, 2023

(54) METHODS, DEVICES, AND MEDIUM FOR COMMUNICATION

(71) Applicant: NEC CORPORATION, Tokyo (JP)

(72) Inventors: Da WANG, Beijing (CN); Gang WANG, Beijing (CN)

(73) Assignee: NEC CORPORATION, Tokyo (JP)

(21) Appl. No.: 18/012,542

(22) PCT Filed: Jun. 23, 2020
(86) PCT No.: PCT/CN2020/097740

§ 371 Date: Dec. 22, 2022

(51) Int. Cl. H04W 24/02; H04W 76/19; H04W 76/15

(52) U.S. Cl. CPC H04W 24/02; H04W 76/19; H04W 76/15

(57) ABSTRACT

Embodiments of the present disclosure relate to methods, devices, and medium for communication. A method of communication comprises receiving, at a terminal device from a first network device, a first indication to deactivate a cell group of a second network device, the first network device being a master node serving the terminal device and the second network device being a secondary node serving the terminal device. The method further comprises discarding data units of a data link layer of the terminal device, the data units used for transmission on the cell group.

### TECHNICAL FIELD

Embodiments of the present disclosure generally relate to the field of telecommunication, and in particular, to methods, devices, and medium for communication.

### BACKGROUND

Dual Connectivity is a mode of operation where a terminal device (for example, user equipment, UE) can be configured to utilize radio resources provided by two network devices (for example, two base stations). A first network device serves the terminal device as a Master Node (MN), and a second network device serves the terminal device as a Secondary Node (SN). The MN and SN are connected via a non-ideal back-haul over a network interface and at least the MN is connected to a core network.

The MN and SN may be associated with one or more serving cells. In a carrier aggregation (CA) scenario, each of the MN and SN may be associated with a group of serving cells including a primary cell (PCell) and optionally one or more secondary cells (SCells). The group of serving cells associated with the MN is referred to as a Master Cell Group (MCG) and the group of serving cells associated with the SN is referred to as a Secondary Cell Group (MCG). In some cases, the SCG needs to be suspended to reduce power consumption for example. However, mechanism of SCG suspension has not be specified.

### SUMMARY

In general, example embodiments of the present disclosure provide a solution for SCG suspension.

In a first aspect, there is provided a method of communication. The method comprises receiving, at a terminal device from a first network device, a first indication to deactivate a cell group of a second network device, the first network device being a master node serving the terminal device and the second network device being a secondary node serving the terminal device; and discarding data units of a data link layer of the terminal device, the data units used for transmission on the cell group.

In a second aspect, there is provided a method of communication. The method comprises receiving, at a terminal device from a first network device, an indication to activate a cell group of a second network device, the first network device being a master node serving the terminal device and the second network device being a secondary node serving the terminal device; starting a timer with an upper value configured by the first network device; and initiating a random access procedure on a primary cell of the cell group.

In a third aspect, there is provided a terminal device. The network device includes a processing unit; and a memory coupled to the processing unit and storing instructions thereon, the instructions, when executed by the processing unit, causing the device to perform the method according to the first aspect.

In a fourth aspect, there is provided a terminal device. The terminal device includes a processing unit; and a memory coupled to the processing unit and storing instructions thereon, the instructions, when executed by the processing unit, causing the device to perform the method according to the second aspect.

In a fifth aspect, there is provided a computer readable medium having instructions stored thereon, the instructions, when executed on at least one processor, causing the at least one processor to carry out the method according to the first aspect.

In a sixth aspect, there is provided a computer readable medium having instructions stored thereon, the instructions, when executed on at least one processor, causing the at least one processor to carry out the method according to the second aspect.

Other features of the present disclosure will become easily comprehensible through the following description.

### BRIEF DESCRIPTION OF THE DRAWINGS

Through the more detailed description of some example embodiments of the present disclosure in the accompanying drawings, the above and other objects, features and advantages of the present disclosure will become more apparent, wherein:

FIG. 1 is a block diagram of a communication environment in which embodiments of the present disclosure can be implemented;

FIGS. 2A-2B are signaling charts illustrating processes of triggering SCG suspension according to some embodiments of the present disclosure;

FIG. 3 is a signaling chart illustrating a process of the SCG suspension according to some embodiments of the present disclosure;

FIG. 4 is a block diagram of network protocol layer entities established at terminal device according to some embodiments of the present disclosure;

FIG. 5 is a block diagram of network protocol layer entities established at terminal device according to some embodiments of the present disclosure;

FIGS. 6A-6B are signaling charts illustrating processes of triggering SCG resumption according to some embodiments of the present disclosure;

FIG. 7 is a signaling chart illustrating a process of the SCG resumption according to some embodiments of the present disclosure;

FIG. 8A-8B are schematic diagrams illustrating example messages indicating a failure in resuming SCG according to some embodiments of the present disclosure;

FIG. 9 illustrates another example method of communication implemented at a terminal device in accordance with some embodiments of the present disclosure;

FIG. 10 illustrates another example method of communication implemented at a terminal device in accordance with some embodiments of the present disclosure; and

FIG. 11 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term “network device” refers to a device which is capable of providing or hosting a cell or coverage where terminal devices can communicate. Examples of a network device include, but not limited to, a Node B (NodeB or NB), an Evolved NodeB (eNodeB or eNB), a NodeB in new radio access (gNB) a Remote Radio Unit (RRU), a radio head (RH), a remote radio head (RRH), a low power node such as a femto node, a pico node, a satellite network device, an aircraft network device, and the like. For the purpose of discussion, in the following, some example embodiments will be described with reference to eNB as examples of the network device.

As used herein, the term “terminal device” refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Internet of Everything (IoE) devices, machine type communication (MTC) devices or evolved MTC (eMTC) DEVICES, devices on vehicle for V2X communication where X means pedestrian, vehicle, or infrastructure/network, or image capture devices such as digital cameras, gaming devices, music storage and playback appliances, or Internet appliances enabling wireless or wired Internet access and browsing and the like. In the following description, the terms “terminal device”, “communication device”, “terminal”, “user equipment” and “UE” may be used interchangeably.

In one embodiment, the terminal device may be connected with a first network device and a second network device. One of the first network device and the second network device may be a master node and the other one may be a secondary node. The first network device and the second network device may use different radio access technologies (RATs). In one embodiment, the first network device may be a first RAT device and the second network device may be a second RAT device. In one embodiment, the first RAT device is eNB and the second RAT device is gNB. Information related with different RATs may be transmitted to the terminal device from at least one of the first network device and the second network device. In one embodiment, first information may be transmitted to the terminal device from the first network device and second information may be transmitted to the terminal device from the second network device directly or via the first network device. In one embodiment, information related with configuration for the terminal device configured by the second network device may be transmitted from the second network device via the first network device. Information related with reconfiguration for the terminal device configured by the second network device may be transmitted to the terminal device from the second network device directly or via the first network device.

Communications discussed herein may use conform to any suitable standards including, but not limited to, New Radio Access (NR), Long Term Evolution (LTE), LTE-Evolution, LTE-Advanced (LTE-A), Wideband Code Division Multiple Access (WCDMA), Code Division Multiple Access (CDMA), cdma2000, and Global System for Mobile Communications (GSM) and the like. Furthermore, the communications may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols. The techniques described herein may be used for the wireless networks and radio technologies mentioned above as well as other wireless networks and radio technologies.

As used herein, the singular forms “a”, “an” and “the” are intended to include the plural forms as well, unless the context clearly indicates otherwise. The term “includes” and its variants are to be read as open terms that mean “includes, but is not limited to.” The term “based on” is to be read as “based at least in part on.” The term “one embodiment” and “an embodiment” are to be read as “at least one embodiment.” The term “another embodiment” is to be read as “at least one other embodiment.” The terms “first,” “second,” and the like may refer to different or same objects. Other definitions, explicit and implicit, may be included below.

In some examples, values, procedures, or apparatus are referred to as “best,” “lowest,” “highest,” “minimum,” “maximum,” or the like. It will be appreciated that such descriptions are intended to indicate that a selection among many used functional alternatives can be made, and such selections need not be better, smaller, higher, or otherwise preferable to other selections.

Example Environment

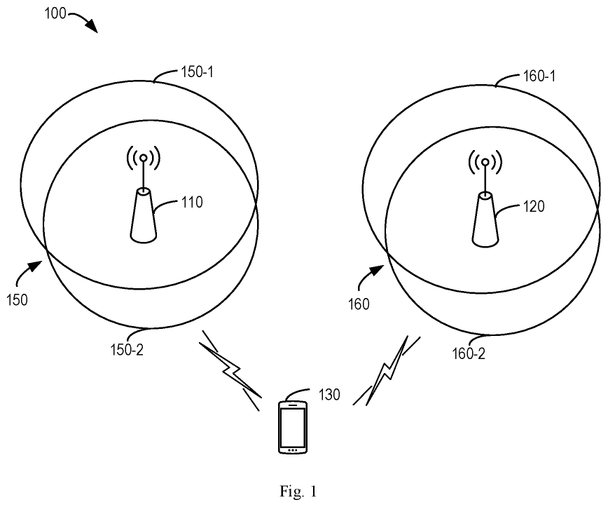

FIG. 1 shows an example communication environment 100 in which example embodiments of the present disclosure can be implemented. In the example of FIG. 1, a plurality of network devices 110, 120 are deployed to serve a terminal device 130. The network device 110 serves the terminal device 130 as the MN, while the network device 120 serves the terminal device 130 as the SN.

The serving areas of the network devices 110, 120 are called as cells. As shown in FIG. 1, a group of cells of the network device 110 includes a primary cell 150-1 and a secondary cell 150-2. Since the network device 110 serves as the MN, the group of cells of the network device 110 is referred to as MCG 150 and the primary cell 150-1 is also referred to as PCell 150-1.

A group of cells of the network device 120 includes a primary cell 160-1 and a secondary cell 160-2. Since the network device 120 serves as the SN, the group of cells of the network device 120 is referred to as SCG 160 and the primary cell 160-1 is also referred to as PSCell 160-1. The PCell 150-1 and PSCell 160-1 may be collectively referred to as SpCell.

It is to be understood that the number of SCells in FIG. 1 is given for the purpose of illustration without suggesting any limitations to the present disclosure. The network devices 110, 120 may provide any suitable number of SCells for serving the terminal device 130.

Communications between the terminal device 130 and the network devices 110, 120 may be implemented according to any proper communication protocol(s). Communication in a direction from a terminal device 130 towards the network device 110 or 120 is referred to as UL communication, while communication in a reverse direction from the network device 110 or 120 towards the terminal device 130 is referred to as DL communication. The terminal device 130 can move amongst the coverage areas of the network devices 110, 120 and possibly other network devices.

In UL communication, the terminal device 130 may transmit UL data and control information to the network device 110 or 120 via a UL channel. In some examples, the UL data may be transmitted in a physical uplink shared channel (PUSCH) and/or any other UL channels that are available used for data transmission. In some examples, the UL control information may be transmitted in a physical uplink control channel (PUCCH) and/or any other UL channels that are available for transmission of control information. In DL transmission, the network device 110 or 120 may transmit DL data and control information to the terminal device 130 via a DL channel. In some examples, the DL data may be transmitted in a physical downlink shared channel (PDSCH) and/or any other DL channels that are available used for data transmission. In some examples, the DL control information may be transmitted in a physical uplink control channel (PDCCH) and/or any other DL channels that are available for transmission of control information.

The DC provided by the network devices 110, 120 may comprise any suitable type of Multi-Radio Dual Connectivity (MR-DC), including but not limited to E-UTRA (Evolved Universal Terrestrial Radio Access)-NR Dual Connectivity (EN-DC), NGEN-DC and NR-DC. In the case of EN-DC, the network device 110 is an eNB and the network device 120 is a gNB. In the case of NGEN-DC, the network device 110 is a gNB and the network device 120 is an eNB. In the case of NR-DC, the network devices 110 and 120 are both gNBs.

It is to be understood that the number and type of devices in FIG. 1 are given for the purpose of illustration without suggesting any limitations to the present disclosure. The communication environment 100 may include any suitable number of network devices and/or terminal devices adapted for implementing implementations of the present disclosure. Further, the communication environment 100 may include any other devices than the network devices and the terminal devices, such as a core network element, but they are omitted here so as to avoid obscuring the present invention.

In a communication environment, power consumption of a terminal device (e.g., a UE) is a big issue. Existing power saving solutions for CA scenario comprise SCell activation and deactivation. To enable reasonable power consumption (for example, battery consumption) of UE when CA is configured, an activation/deactivation mechanism of SCells is supported. When an SCell is deactivated, the UE does not need to receive the corresponding PDCCH or PDSCH, cannot transmit in the corresponding uplink, nor is it required to perform Channel Quality Indicator (CQI) measurements. Conversely, when an SCell is activated, the UE shall receive PDSCH and PDCCH (if the UE is configured to monitor PDCCH from this SCell) and is expected to be able to perform CQI measurements.

Existing power saving solutions for CA scenario further comprise Scell Dormancy. To enable fast SCell activation when CA is configured, one dormant bandwidth part (BWP) can be configured for an SCell. If the active BWP of the activated SCell is a dormant BWP, the UE stops monitoring PDCCH on the SCell but continues performing channel state information (CSI) measurements, automatic gain control (AGC) and beam management, if configured. Downlink control information (DCI) is used to control entering/leaving the dormant BWP for one or more SCell(s) or one or more SCell group(s). The dormant BWP is one of the UE's dedicated BWPs configured by network via dedicated radio resource control (RRC) signaling. The SpCell and PUCCH SCell cannot be configured with a dormant BWP.

Power saving solution is also needed for DC scenario. As mentioned above, SCG suspension is needed in some cases. Take the EN-DC as an example. Power consumption of the UE and the network is a big issue, due to maintaining two radio links simultaneously. For example, in some cases, power consumption of the UE in NR network is 3 to 4 times higher than that of the UE in the LTE network. In EN-DC deployment, the MN provides the basic coverage. When data rate requirement of the UE changes dynamically, e.g. from high to low, the SN is worth considering to be deactivated or suspended to reduce power consumption. Therefore, an efficient SCG deactivation mechanism should be specified. This efficient SCG deactivation mechanism can also be applied to other MR-DC deployments, including but not limited to NGEN-DC, NR-DC. The terms “SCG suspension” and “SCG deactivation” are used interchangeably herein.

Three options regarding modeling of the SCG suspension have been proposed. In Option 1, all serving cells associated with the SN including PScell and SCells are activated and the active BWP is configured as a dormant BWP. The drawback of this option is that all the serving cells should be configured with at least two RRC-configured BWP. In Option 2, all serving cells associated with the SN including PScell and SCells are deactivated. The drawback of this option is that it requires long time to recover data transmission. In Option 3, the SCells of the SCG should be deactivated, while the PScell of the SCG should be activated and the active BWP is configured as a dormant BWP.

As can be seen from the above, different from SCell activation/deactivation and SCell dormancy (where PSCell can maintain data transmission, thus no high layer handling), in the SCG suspension, neither PSCell nor SCell can transmit/receive data. Therefore, the handling of high layer should be specified for the SCG suspension. However, the SCG suspension mechanism is not clear and only the medium access control (MAC) layer behavior was roughly discussed. Currently there is no specific solution for an efficient SCG suspension mechanism.

Moreover, after the SCG is suspended or deactivated, the MN or SN may decide to resume or activate the suspended SCG as needed. The resumption of the suspended SCG may be referred to as “SCG resumption” or “SCG activation” herein. Therefore, an efficient and robust SCG resumption mechanism should be specified. This efficient and robust SCG resumption can be applied to a variety of MR-DC deployments, including but not limited to the EN-DC, NGEN-DC, NR-DC deployments.

According to example embodiments of the present disclosure, there is proposed a solution for SCG suspension. In this solution, a first network device serves a terminal device as the MN and a second network device serves the terminal device as the SN. The terminal device receives an indication from the first network device to deactivate a cell group of the second network device, i.e., the SCG. This indication is also referred to as a SCG suspension indication. Upon receiving the SCG suspension indication, the terminal device performs a procedure to suspend the SCG. The terminal device at least discards data units of a data link layer of the terminal device and the data units are used for transmission on the SCG. Discarding the data units which would be outdated upon resumption of the SCG is beneficial for achieving reliable SCG suspension and is also beneficial for achieving efficient SCG resumption.

In some embodiments, there is provided a solution for SCG resumption. In this solution, the terminal device receives an indication from the first network device to activate the SCG, which has been previously deactivated. This indication is also referred to as a SCG resumption indication. Upon receiving the SCG resumption indication, the terminal device performs a procedure to resume the SCG. The terminal device starts a timer and initiates a random access procedure on PSCell of the SCG. The timer can be used by the terminal device to determine whether the SCG resumption is successful. If the SCG resumption is not successful, the terminal device may inform the first network device of the failure. In this way, robust SCG resumption can be achieved.

Example Processes of SCG Suspension

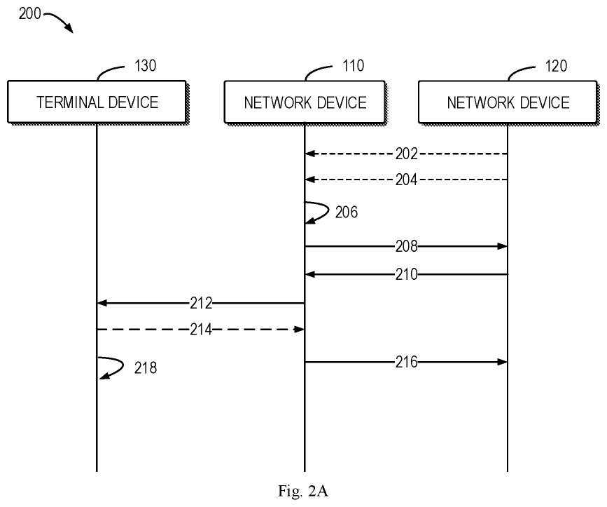

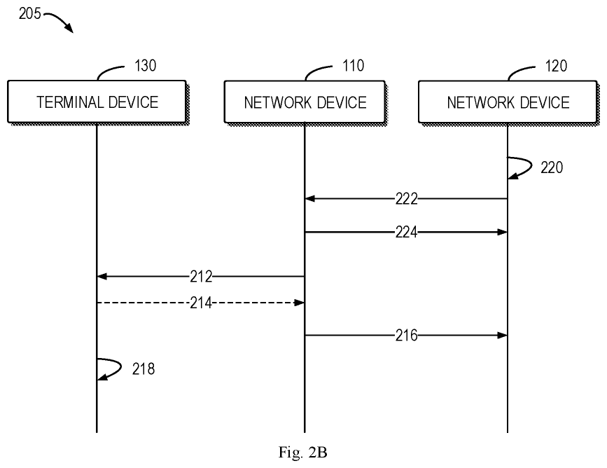

Some example embodiments of the present disclosure will be described in detail below. The SCG suspension may be triggered or initiated by the MN or the SN. FIG. 2A and FIG. 2B are signaling charts illustrating processes 200 and 205 of triggering SCG suspension according to some embodiments of the present disclosure. For the purpose of discussion, the processes 200 and 205 will be described with reference to FIG. 1. The processes 200 and 205 may involve the terminal device 130, the network device 110 and the network device 120. In the process 200 of FIG. 2A, it is the network device 110 acting as the MN to initiate the SCG suspension. In the process 205 of FIG. 2B, it is the network device 120 acting as the SN to initiate the SCG suspension.

The process 200 of FIG. 2A is first discussed. As a prerequisite or a trigger condition, in some embodiments, the network device 120 may transmit 202 an activity notification to the network device 110. The activity notification may notify the network device 110 that the network device 120 is in an inactive state. Alternatively, or in addition, in some embodiments, the network device 120 may transmit 204 a report about secondary RAT data usage to the network device 110. The report may be transmitted periodically.

The network device 110 determines 206 to initiate the SCG suspension based on the activity notification and/or the report about the secondary RAT data usage. For example, if the activity notification indicates that the network device 120 has been in the inactive state for a period of time, or if the report indicates that the network device 110 can handle traffics of the terminal device 130, then the network device 110 may determine to initiate the SCG suspension.

Next, the network device 110 transmits 208 to the network device 120 a request to suspend or deactivate the SCG of the network device 120, which may be referred to as a SCG suspension request. Upon receiving the SCG suspension request, the network device 120 transmits 210 to the network device 110 a response to the SCG suspension request, which may be referred to as a SCG suspension response.

The network device 110 transmits 212 to the terminal device 130 a message to indicate the SCG suspension. This message may be referred to as a SCG suspension message. In some embodiments, upon receiving the SCG suspension message, the terminal device 130 may transmit 214 a response to the network device 110. As an example, the SCG suspension message may be an RRCReconfiguration message and the response may be an RRCReconfigurationComplete message. Other messages, for example, messages specific to the SCG suspension, are also possible.

Upon receiving the response from the terminal device 130, the network device 110 transmits 216 to the network device 120 a message to notify the SCG suspension. As an example, this message may be a SgNBReconfigurationComplete message.

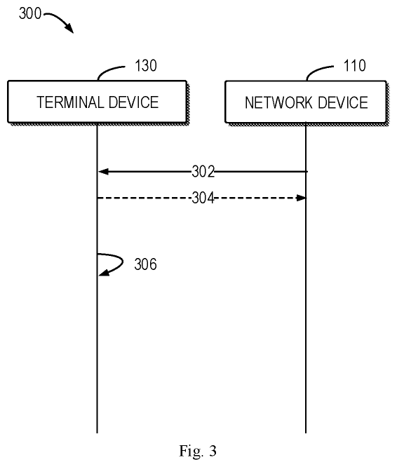

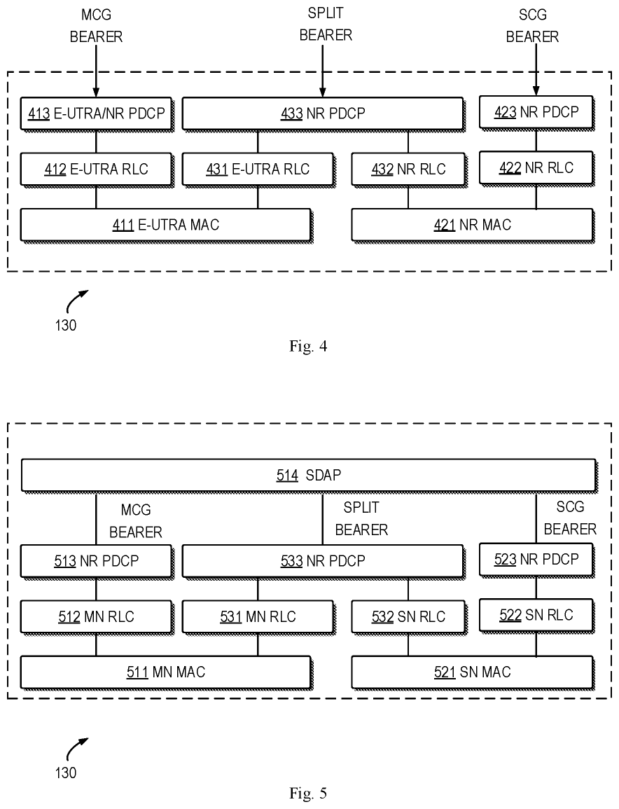

Upon receiving the SCG suspension message from the network device 110, the terminal device 130 performs 218 a procedure to suspend the SCG of the network device 120. This procedure may be referred to as a SCG suspension procedure herein. The SCG suspension procedure will be described below with reference to FIGS. 3 and 4.

It is to be understood that the order of acts shown in FIG. 2A is merely for purpose of illustration without any limitation to the scope of the present disclosure. For example, upon receiving the SCG suspension message, the terminal device 130 may perform 218 the SCG suspension procedure and then transmit 214 the response to the network device 110. Alternatively, upon receiving the SCG suspension message, the terminal device 130 may perform 218 the SCG suspension procedure and transmit 214 the response to the network device 110 concurrently.

Reference is made to FIG. 2B where the network device 120 acting as the SN initiates the SCG suspension. In the process 205 of FIG. 2B, the network device 120 determines 220 to initiate the SCG suspension. For example, if the network device 120 has not handled traffics from the terminal device 130 for a period of time, the network device 120 may determine to suspend the SCG.

The network device 120 transmits 222 to the network device 110 a requirement to suspend the SCG. This requirement may be also referred to as a SCG suspension requirement. Upon receiving the SCG suspension requirement, the network device 110 transmits 224 to the network device 120 a confirmation to the SCG suspension requirement, which may be referred to as a SCG suspension confirmation.

The network device 110 also transmits 212 to the terminal device 130 a SCG suspension request. Acts with the same reference signs as in FIG. 2A are same as those described with reference to FIG. 2A and thus are not repeatedly described here.

As can be seen from the processes 200 and 205, whether the SCG suspension is initiated by the MN or the SN, it is the MN to indicate the terminal device 130 to suspend the SCG associated with the SN. FIG. 3 is a signaling chart illustrating a process 300 of the SCG suspension according to some embodiments of the present disclosure. For the purpose of discussion, the process 300 will be described with reference to FIG. 1. The process 300 may involve the terminal device 130 and the network device 110 acting as the MN.

In the process 300, the network device 110 transmits 302 to the terminal device 130 an indication to suspend or deactivate the SCG 160 of the network device 120. For example, if the network device 110 determines to initiate the SCG suspension (as shown in the process 200), it may transmit the indication. As another example, if the network device 110 receives the SCG suspension requirement from the network device 120 (as shown in the process 205), it may transmit the indication.

This indication may be also referred to as “first indication” or “SCG suspension indication” herein. The SCG suspension indication may be implemented by any suitable signaling. In some embodiments, the SCG suspension indication may be included in an RRC message. In these embodiments, upon receiving the RRC message, the terminal device 130 may transmit 304 a corresponding RRC message to the network device 110 as a response. As an example, the network device 110 may transmit an RRCReconfiguration message to indicate the SCG suspension. Accordingly, the terminal device 130 may transmit an RRCReconfigurationComplete message to the network device 110 as the response.

In such embodiments, RRC signaling is used to carry the SCG suspension indication. In this way, communications between different protocol layers at the terminal device 130 can be reduced, which can improve the efficiency of the SCG suspension.

Upon receiving the SCG suspension indication, the terminal device 130 performs the SCG suspension procedure. Specifically, the terminal device 130 discards 306 data units for transmission on the SCG. The data units are buffered at the data link layer of the terminal device 130.

The buffered data units comprise buffered signaling for signaling radio bear 3 (SRB3), which is a direct signaling radio bear (SRB) between the terminal device 130 and the network device 120. The buffered signaling would be outdated and would mislead the network device 120 when the SCG of the network device 120 is resumed from the suspension. The outdated signaling would mislead the network device 120. To avoid the outdated signaling from being transmitted to the network device 120 when the SCG is resumed, the buffered signaling should be discarded upon receiving the SCG suspension indication.

Likewise, the buffered data units comprise buffered data for data radio bears (DRB) between the terminal device 130 and the network device 120. The buffered data would be outdated and useless when the SCG of the network device 120 is resumed from the suspension. To avoid the outdated and useless data from being transmitted to the network device 120 when the SCG is resumed, the buffered data should be discarded upon receiving the SCG suspension indication.

To better understand the SCG suspension procedure of the present disclosure, example radio protocol architectures in MR-DC are described with reference to FIGS. 4 and 5. At the side of the terminal device 130, there are three types of DRBs, i.e., an MCG bearer, a split bearer and an SCG bearer. The MCG bearer refers to a radio bearer with a radio link control (RLC) bearer (or two RLC bearers, in case of CA packet duplication) only in the MCG. The SCG bearer refers to a radio bearer with an RLC bearer (or two RLC bearers, in case of CA packet duplication) only in the SCG. The split bearer refers to a radio bearer with RLC bearers both in MCG and SCG.

FIG. 4 is a block diagram of data link layer entities established at the terminal device 130 according to some embodiments of the present disclosure. The data link layer entities shown in FIG. 4 are based on radio protocol architectures in EN-DC. At a MAC layer, an E-UTRA MAC entity 411 may be established for both the MCG bearer and the split bearer, and an NR MAC entity 421 may be established for both the SCG bearer and the split bearer. At an RLC layer, an E-UTRA RLC entity 412 may be established for the MCG bearer and another E-UTRA RLC entity 431 may be established for the split bearer. Similarly, an NR RLC entity 422 may be established for the SCG bearer and another NR RLC entity 432 may be established for the split bearer. At a packet data convergence protocol (PDCP) layer, an E-UTRA/NR PDCP entity 413 may be established for the MCG bearer, an NR PDCP entity 433 may be established for the split bearer and an NR PDCP entity 423 may be established for the SCG bearer.

FIG. 5 is a block diagram of data link layer entities established at the terminal device 130 according to some embodiments of the present disclosure. The data link layer entities shown in FIG. 5 are based on radio protocol architectures in MR-DC with 5G core network (5GC), for example the NGEN-DC and NR-DC. At the MAC layer, an MN MAC entity 511 may be established for both the MCG bearer and the split bearer, and an SN MAC entity 521 may be established for both the SCG bearer and the split bearer. At the RLC layer, an MN RLC entity 512 may be established for the MCG bearer and another MN RLC entity 531 may be established for the split bearer. Similarly, an SN RLC entity 522 may be established for the SCG bearer and another SN RLC entity 532 may be established for the split bearer. At the PDCP layer, an NR PDCP entity 513 may be established for the MCG bearer, another NR PDCP entity 533 may be established for the split bearer and a further NR PDCP entity 523 may be established for the SCG bearer. Different from the architecture shown in FIG. 4, there is a service data application protocol (SDAP) layer above the PDCP layer. An SDAP entity 514 may be established for the three types of bearers.

Since split SRB is not supported for the SRB3, the radio protocol architecture for the SRB3 is simple and thus is not depicted in detail herein.

Reference is now made back to FIG. 3. To discard data units at the RLC layer, one or more of the following acts may be performed at the terminal device 130. In some embodiments, an RLC entity of the SRB3 may be re-established. For example, if the SCG suspension indication is received in an RRC message, the RRC layer may request a re-establishment of the RLC entity of the SRB3. In some embodiments, an RLC entity of the SCG bearer may be re-established. For example, if the SCG suspension indication is received in the RRC message, the RRC layer may request a re-establishment of the RLC entities of the SCG bearer. In the EN-DC deployment, the NR RLC entity 422 as shown in FIG. 4 may be re-established. In the NGEN-DC or NR-DC deployment, the SN RLC entity 522 may be re-established.

To re-establish the RLC entity (either of the SRB3 or of the SCG bearer), the terminal device 130 may discard all RLC service data units (SDUs), RLC SDU segments, and RLC protocol data unit (PDUs) (if any) of the RLC entity. The terminal device 130 may stop and reset all the timers maintained by the RLC entity and reset all state variables to their initial values.

Therefore, in such embodiments, not only the PDUs and SDUs of the RLC layer are discarded, but also the timers and state variables are reset. Since the timers and state variables are reset upon the SCG suspension, resetting of timers and state variables can be avoided when the SCG is resumed. This may help achieving an efficient SCG resumption.

To discard data units of the PDCP layer, one or more of the following acts may be performed at the terminal device 130. In some embodiments, the terminal device 130 may cause a PDCP entity of the SRB3 to discard PDCP PDUs and PDCP SDUs of the PDCP entity. For example, an upper layer (e.g., the RRC layer) may trigger the PDCP entity of the SRB3 to perform a PDCP SDU discard. It is to be understood that for SRB, when the upper layer requests the PDCP SDU discard, the PDCP entity shall discard all the stored PDCP PDUs and PDCP SDUs. Therefore, both the PDCP PDUs and PDCP SDUs of the PDCP entity can be discarded by performing the PDCP SDU discard requested by the upper layer.

In such embodiments, operations at the PDCP layer are different from the operations at the RLC layer. At the PDCP layer, the buffered data units are discarded without re-establishment of the PDCP entities. The PDCP layer provides a function of ciphering and deciphering. If the PDCP entities were re-established, new keys for the ciphering and deciphering would be required when the SCG is resumed. Therefore, in the embodiments without the re-establishment of the PDCP entities, the efficiency of the SCG suspension can be improved. Accordingly, without the need to provide the new keys when the SCG is resumed, the efficiency of the SCG resumption can also be improved.

In some embodiments, the terminal device 130 may cause a PDCP entity of the SCG bearer to discard PDCP PDUs and PDCP SDUs of the PDCP entity. For example, the PDCP entity of the SCG bearer may be indicated by an upper layer (e.g., the RRC layer) to discard all the stored PDCP PDUs and PDCP SDUs. In the EN-DC deployment, the NR PDCP entity 423 as shown in FIG. 4 may discard all the PDCP PDUs and PDCP SDUs stored therein. In the NGEN-DC or NR-DC deployment, the NR PDCP entity 523 may discard all the PDCP PDUs and PDCP SDUs stored therein.

Additionally, in some embodiments, upon receiving the SCG suspension indication, the terminal device 130 may reset a MAC entity for the SCG, which may be referred to as “SCG MAC entity”. For example, an upper layer such as the RRC layer may request reset of the SCG MAC entity. If the reset of the SCG MAC entity is requested by the upper layer, the terminal device 130 may perform a set of acts, including but not limited to, stopping all timers, stopping ongoing random access channel (RACH) procedure, flushing a variety of buffers, cancelling a variety of triggered procedures, resetting a variety of counters.

If the SCG suspension indication is received at a high layer (for example, the RRC layer), the high layer may indicate the SCG MAC entity of the SCG suspension. The terminal device 130 may further suspend transmission on the SCG, including transmission of data and signaling. For example, the terminal device 130 may suspend SCG transmission for all SRBs and DRBs.

In the above example embodiments, the SCG suspension or deactivation procedure is described. As a specific example without any limitation as to the scope of the present disclosure, upon receiving the SCG suspension indication, the terminal device 130 may perform one or more of the following: resetting the SCG MAC entity and indicating the SCG MAC entity of the SCG suspension; suspending the SCG transmission for all the SRBs and DRBs; re-establishing the RLC entity of the SRB3; triggering the PDCP entity of the SRB3 to perform the SDU discard; indicating the PDCP entity of the SCG bearer to discard the buffered PDUs and SDUs; re-establishing the RLC entity of the SCG bearer.

Example Processes of SCG Resumption

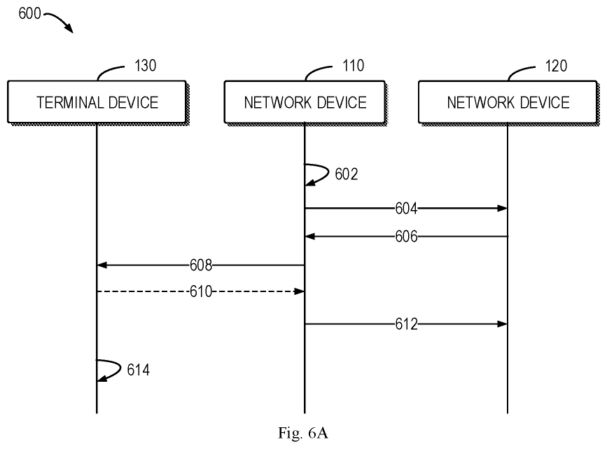

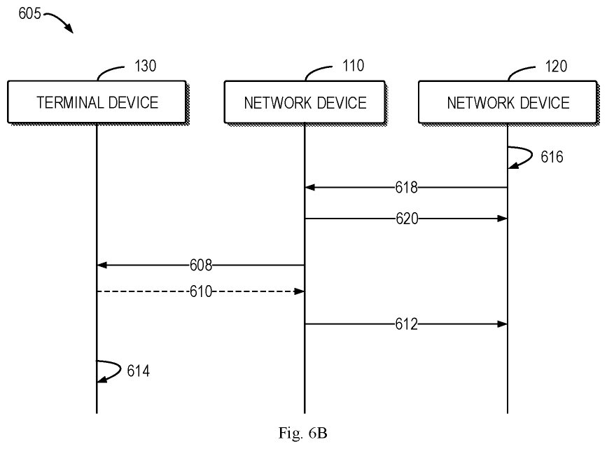

The SCG resumption may be triggered or initiated by the MN or the SN. FIG. 6A and FIG. 6B are signaling charts illustrating processes 600 and 605 of triggering SCG resumption according to some embodiments of the present disclosure. For the purpose of discussion, the processes 600 and 605 will be described with reference to FIG. 1. The processes 600 and 605 may involve the terminal device 130, the network device 110 and the network device 120. In the process 600 of FIG. 6A, it is the network device 110 acting as the MN to initiate the SCG resumption. In the process 605 of FIG. 6B, it is the network device 120 acting as the SN to initiate the SCG resumption.

The process 600 of FIG. 6A is first discussed. The network device 110 determines 602 to initiate the SCG resumption. For example, if the network device 110 cannot handle traffics of the terminal device 130, the network device 110 may determine to initiate the SCG resumption.

Next, the network device 110 transmits 604 to the network device 120 a request to resume or activate the SCG of the network device 120, which may be referred to as a SCG resumption request. Upon receiving the SCG resumption request, the network device 120 transmits 606 to the network device 110 a response to the SCG resumption request, which may be referred to as a SCG resumption response.

The network device 110 transmits 608 to the terminal device 130 a message to indicate the SCG resumption. This message may be referred to as a SCG resumption message. In some embodiments, upon receiving the SCG resumption message, the terminal device 130 may transmit 610 a response to the network device 110. As an example, the SCG resumption message may be an RRCReconfiguration message and the response may be an RRCReconfigurationComplete message. Other messages, for example, messages specific to the SCG resumption, are also possible.

Upon receiving the response from the terminal device 130, the network device 110 transmits 612 to the network device 120 a message to notify the SCG resumption. As an example, this message may be a SgNBReconfigurationComplete message.

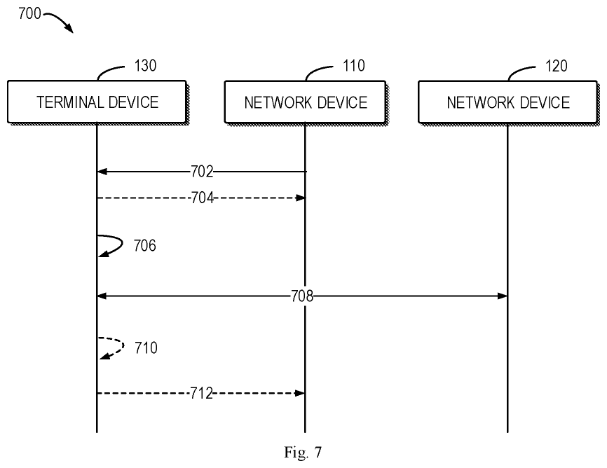

Upon receiving the SCG resumption message from the network device 110, the terminal device 130 performs 614 a procedure to resume the SCG of the network device 120. This procedure may be referred to as a SCG resumption procedure herein. The SCG resumption procedure will be described below with reference to FIG. 7.

It is to be understood that the order of acts shown in FIG. 6A is merely for purpose of illustration without any limitation to the scope of the present disclosure. For example, upon receiving the SCG resumption message, the terminal device 130 may perform 614 the SCG resumption procedure and then transmit 610 the response to the network device 110. Alternatively, upon receiving the SCG resumption message, the terminal device 130 may perform 614 the SCG resumption procedure and transmit 610 the response to the network device 110 concurrently.

Reference is made to FIG. 6B where the network device 120 acting as the SN initiates the SCG resumption. In the process 605 of FIG. 6B, the network device 120 determines 616 to initiate the SCG resumption.

The network device 120 transmits 618 to the network device 110 a requirement to resume the SCG. This requirement may be also referred to as a SCG resumption requirement. Upon receiving the SCG resumption requirement, the network device 110 transmits 620 to the network device 120 a confirmation to the SCG resumption requirement, which may be referred to as a SCG resumption confirmation.

The network device 110 transmits 608 the SCG resumption message to the terminal device 130. Acts with the same reference signs as in FIG. 6A are same as those described with reference to FIG. 6A and thus are not repeatedly described here.

As can be seen from the processes 600 and 605, whether the SCG resumption is initiated by the MN or the SN, it is the MN to indicate the terminal device 130 to resume or activate the SCG associated with the SN. FIG. 7 is a signaling chart illustrating a process 700 of the SCG resumption according to some embodiments of the present disclosure. For the purpose of discussion, the process 700 will be described with reference to FIG. 1. The process 700 may involve the terminal device 130, the network device 110 acting as the MN and the network device 120 acting as the SN.

In the process 700, the network device 110 transmits 702 to the terminal device 130 an indication to resume or activate the SCG 160 of the network device 120. For example, if the network device 110 determines to initiate the SCG resumption (as shown in the process 600), it may transmit the indication. As another example, if the network device 110 receives the SCG resumption requirement from the network device 120 (as shown in the process 605), it may transmit the indication.

This indication may be also referred to as “second indication” or “SCG resumption indication” herein. The SCG resumption indication may be implemented by any suitable signaling. In some embodiments, the SCG resumption indication may be included in an RRC message. In these embodiments, upon receiving the RRC message, the terminal device 130 may transmit 704 a corresponding RRC message to the network device 110 as a response. As an example, the network device 110 may transmit an RRCReconfiguration message to indicate the SCG resumption. An information element (IE) of the RRCReconfiguration message may be used to indicate the SCG resumption. Accordingly, the terminal device 130 may transmit an RRCReconfigurationComplete message to the network device 110 as a response.

In such embodiments, RRC signaling is used to carry the SCG resumption indication. In this way, communications between different protocol layers at the terminal device 130 can be reduced, which can help achieving efficient SCG resumption.

Upon receiving the SCG resumption indication, the terminal device 130 performs the SCG resumption procedure. Specifically, the terminal device 130 starts 706 a timer with an upper value configured by the network device 110. The timer represented by “T3xx” is used to determine whether the SCG resumption is successful or not.

In some embodiments, the upper value “t3xx” for the timer T3xx may be indicated to the terminal device 130 along with the SCG resumption indication. In the case where the SCG resumption indication is included in the RRC message, the RRC message may further comprise an IE indicating the upper value t3xx. In some embodiments, the upper value t3xx for the timer T3xx may be indicated to the terminal device 130 separately from the SCG resumption indication. For example, the upper value t3xx may be a preconfigured or predefined value.

The timer T3xx may be a timer specific to the SCG resumption indication. Alternatively, or in addition, the timer T3xx may reuse an existing timer, for example a timer T304 for reconfiguration with synch, a timer T319 for RRC resume request. More details about the timer T3xx will be described below with respect to Table 1.

Still refer to FIG. 7. Upon receiving the SCG resumption indication, the terminal device 130 initiates 708 a random access (RA) procedure on the PSCell 160-1, that is, the primary cell of the SCG. For example, the terminal device 130 may transmit a random access preamble on the PSCell 160-1 to the network device 120.

In some embodiments, the RA procedure may be based on contention-free random access (CFRA). For example, the network device 120 may transmit information about a resource for the CFRA to the network device 110 in the SCG resumption response (as described with reference to FIG. 6A) or in the SCG resumption requirement (as described with reference to FIG. 6B). The network device 110 may include the information about the resource in the SCG resumption indication or transmit the information about the resource to the terminal device 130 along with the SCG resumption indication. The terminal device 130 may transmit the random access preamble on the PSCell 160-1 using the resource determined from the SCG resumption indication. In such embodiments, the efficiency of the SCG resumption can be improved by allocating the dedicated resource for the CFRA.

Additionally, upon receiving the SCG resumption indication, the terminal device 130 may further resume the SCG transmission for all SRBs and DRBs and resume the SCG 160. For example, if the SCG resumption indication is received at an upper layer (for example, the RRC layer), the upper layer may indicate the lower layer (for example, the MAC layer) to resume the SCG 160.

Continuing the process 700, if the random access procedure is successful, the terminal device 130 may stop the timer T3xx. For example, if a random access response is received from the network device 120, the terminal device 130 may determine that the SCG resumption is successful and stop the timer T3xx.

If the timer T3xx expires, the terminal device 130 may determine 710 that the SCG resumption is failed. The terminal device 130 may transmit 712 to the network device 110 a message indicating a failure in resuming or activating the SCG 160. The failure in resuming or activating the SCG 160 may be referred to as “SCG resumption failure”.

The following Table 1 shows some attributes of the timer T3xx, which can be summarized from the above description. A starting condition for the timer T3xx is receipt of the SCG resumption indication and a stopping condition for the timer T3xx is successful completion of the random access on the corresponding PSCell 160. At expiry of the timer T3xx, the terminal device 130 may inform the network device about the SCG resumption failure for example by transmitting the message indicating the SCG resumption failure to the network device. It is to be understood that in the case where the timer T3xx reuses the timer T304 or T319, the attributes in Table 1 may be added to the reused timer.

TABLE 1
Attributes of timer T3xx

| timer | Start | stop | at expiry |
|---|---|---|---|
| T3xx | Upon receiving | Upon successful | Inform the network |
| | the SCG | completion of random | device about the SCG |
| | resumption | access on the | resumption failure |
| | indication | corresponding PSCell | |

The SCG resumption failure may be indicated by a failure type specific to the SCG resumption. For example, a new failure type may be defined for the SCG resumption. Alternatively, or in addition, other failure type defined for another procedure can be reused to indicate the SCG resumption failure. For example, a failure type defined for reconfiguration with sync of the SCG may be reused.

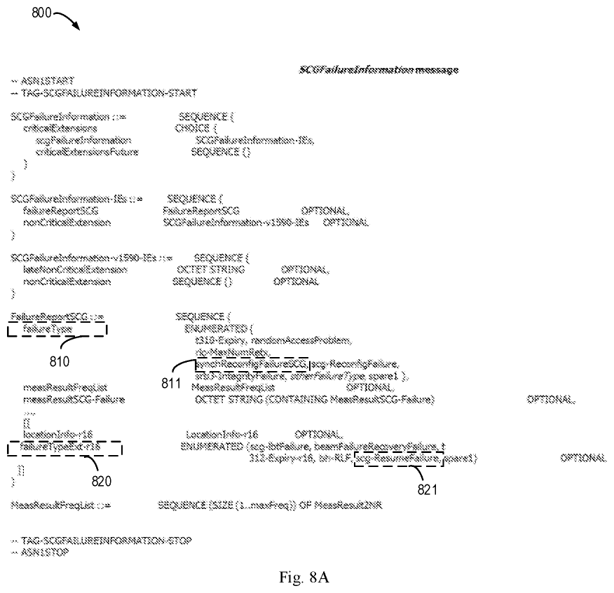

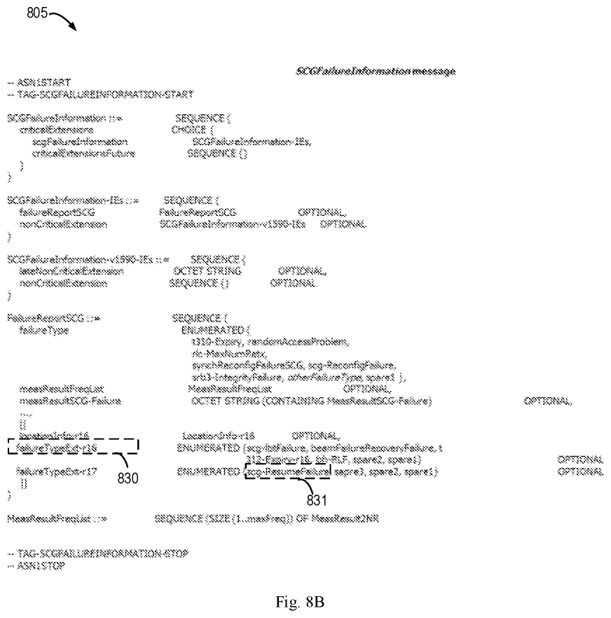

In some embodiments, the message indicating the SCG resumption failure may be a SCGfailureinformation message. FIG. 8A and FIG. 8B are schematic diagrams illustrating example messages 800 and 805 indicating the SCG resumption failure according to some embodiments of the present disclosure.

In some embodiments, an existing failure type may be reused to indicate the SCG resumption failure. For example, as shown in FIG. 8A, a “synchReconfigFailureSCG” failure type 811 in the “failureType” IE 810 may be reused to indicate the SCG resumption failure.

In some embodiments, a new failure type may be introduced to indicate the SCG resumption failure. The new failure type may be added to an existing IE. As shown in FIG. 8A, a “scg-ResumeFailure” failure type 821 may be added to the “failureTypeExt-r16” IE 820. The “scg-ResumeFailure” failure type 821 is a failure type specific to the SCG resumption failure. Alternatively, a new IE including the new failure type may be added. As shown in FIG. 8B, a “failureTypeExt-r17” IE 830 may be added to the SCGfailureinformation message and a “scg-ResumeFailure” failure type 831 may be a failure type specific to the SCG resumption failure.

Still refer to FIG. 7. Upon expiration of the timer T3xx, the terminal device 130 may cancel the random access procedure for the SCG resumption. The terminal device 130 may perform the SCG suspension procedure described above with reference to FIG. 3. For example, the terminal device 130 may suspend the SCG transmission for all SRBs and DRBs and reset the SCG MAC entity.

Example Method

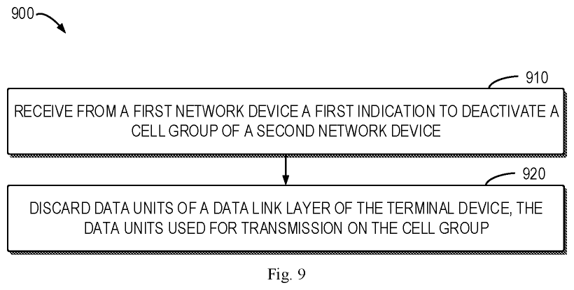

FIG. 9 illustrates a flowchart of an example method 900 according to some embodiments of the present disclosure. The method 900 can be implemented at the terminal device 130 as shown in FIG. 1. It is to be understood that the method 900 may include additional blocks not shown and/or may omit some blocks as shown, and the scope of the present disclosure is not limited in this regard. For the purpose of discussion, the method 900 will be described from the perspective of the terminal device 130 with reference to FIG. 1.

At block 910, the terminal device 130 receives from a first network device 110, a first indication to deactivate a cell group of a second network device 120. The first network device 110 is a master node serving the terminal device 130 and the second network device 120 is a secondary node serving the terminal device 130. At block 920, the terminal device 120 discards data units of a data link layer of the terminal device 130, the data units used for transmission on the cell group.

In some embodiments, at least one radio link control (RLC) entity has been previously established for a RLC layer of the terminal device 130 and discarding the data units comprises: re-establishing a first RLC entity of a signaling radio bearer on the cell group to discard a protocol data unit (PDU) of the first RLC entity and a service data unit (SDU) of the first RLC entity; and re-establishing a second RLC entity of a data radio bearer on the cell group to discard a PDU of the second RLC entity and a SDU of the second RLC entity.

In some embodiments, at least one packet data convergence protocol (PDCP) entity has been previously established for a PDCP layer of the terminal device 130 and discarding the data units comprises: causing a first PDCP entity of a signaling radio bearer on the cell group to discard a protocol data unit (PDU) of the first PDCP entity and a service data unit (SDU) of the first PDCP entity; and causing a second PDCP entity of a data radio bearer on the cell group to discard a PDU of the second PDCP entity and a SDU of the second PDCP entity.

In some embodiments, the method 900 further comprises: resetting a media access control (MAC) entity for the cell group, the MAC entity established for a MAC layer of the terminal device 130; and suspending the transmission on the cell group.

In some embodiments, the first indication is comprised in a radio resource control (RRC) reconfiguration message, and the method 900 further comprises: in response to receiving the RRC reconfiguration message, transmitting an RRC reconfiguration complete message to the first network device 110.

In some embodiments, the method 900 further comprises: receiving, from the first network device 110, a second indication to activate the cell group of the second network device 120; starting a timer with an upper value configured by the first network device 110; and initiating a random access procedure on a primary cell of the cell group.

In some embodiments, the method 900 further comprises: in accordance with a determination that the random access procedure is successful, stopping the timer.

In some embodiments, initiating the random access procedure comprises: determining, from the second indication, a resource for the random access procedure; and initiating the random access procedure by transmitting a random access request on the primary cell using the determined resource.

In some embodiments, the method 900 further comprises: in accordance with a determination that the timer expires, transmitting, to the first network device 110, a message indicating a failure in activating the cell group of the second network device 120.

In some embodiments, the message is defined for failure information concerning the cell group and the failure is indicated by at least one of: a failure type specific to activation of the cell group, or a failure type defined for reconfiguration with sync of the cell group.

In some embodiments, the method 900 further comprises: in accordance with a determination that the timer expires, resetting a media access control (MAC) entity for the cell group, the MAC entity established for a MAC layer of the terminal device 130; and suspending the transmission over the cell group.

In some embodiments, the second indication and information concerning the upper value are comprised in a radio resource control (RRC) reconfiguration message, and the method 900 further comprises: in response to receiving the RRC reconfiguration message, transmitting an RRC reconfiguration complete message to the first network device 110.

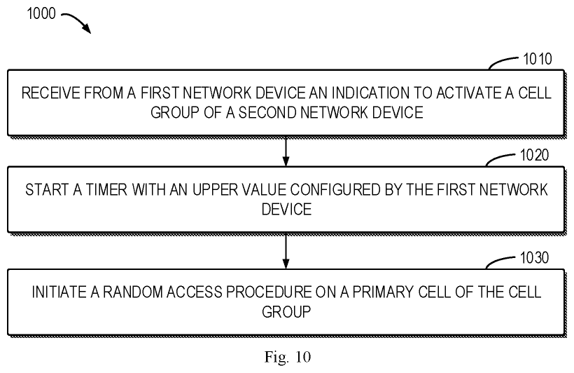

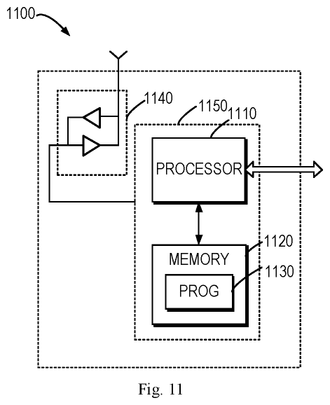

FIG. 10 illustrates a flowchart of an example method 1000 according to some embodiments of the present disclosure. The method 1000 can be implemented at the terminal device 130 as shown in FIG. 1. It is to be understood that the method 1000 may include additional blocks not shown and/or may omit some blocks as shown, and the scope of the present disclosure is not limited in this regard. For the purpose of discussion, the method 1000 will be described from the perspective of the terminal device 130 with reference to FIG. 1.

At block 1010, the terminal device 130 receives from a first network device 110, an indication to activate a cell group of a second network device 120. The first network device 110 is a master node serving the terminal device 130 and the second network device 120 is a secondary node serving the terminal device 130. At block 1020, the terminal device 130 starts a timer with an upper value configured by the first network device. At block 1030, the terminal device 130 initiates a random access procedure on a primary cell of the cell group.

In some embodiments, the method 1000 further comprises: in accordance with a determination that the random access procedure is successful, stopping the timer.

In some embodiments, initiating the random access procedure comprises: determining, from the indication, a resource for the random access procedure; and initiating the random access procedure by transmitting a random access request on the primary cell using the determined resource.

In some embodiments, the method 1000 further comprises: in accordance with a determination that the timer expires, transmitting, to the first network device 110, a message indicating a failure in activating the cell group of the second network device 120.

In some embodiments, the message is defined for failure information concerning the cell group and the failure is indicated by at least one of: a failure type specific to activation of the cell group, or a failure type defined for reconfiguration with sync of the cell group.

In some embodiments, the method 1000 further comprises: in accordance with a determination that the timer expires, resetting a media access control (MAC) entity for the cell group, the MAC entity established for a MAC layer of the terminal device 130; and suspending the transmission over the cell group.

In some embodiments, the indication and information concerning the upper value are comprised in a radio resource control (RRC) reconfiguration message, and the method 900 further comprises: in response to receiving the RRC reconfiguration message, transmitting an RRC reconfiguration complete message to the first network device 110.

In some embodiments, there is provided a method which can be implemented at a network device, for example, the network device 110 as shown in FIG. 1. The method may comprise acts performed by the network device 110 as described with reference to FIGS. 2A, 2B, 3, 6A, 6B and 7.

In some embodiments, there is provided a method which can be implemented at a network device, for example, the network device 120 as shown in FIG. 1. The method may comprise acts performed by the network device 120 as described with reference to FIGS. 2A, 2B, 6A, 6B and 7.

Example Device

FIG. 11 is a simplified block diagram of a device 1100 that is suitable for implementing embodiments of the present disclosure. The device 1100 can be considered as a further example implementation of the terminal device 130, the network device 120, or the network device 110 as shown in FIG. 1. Accordingly, the device 1100 can be implemented at or as at least a part of the terminal device 130, the network device 120, or the network device 110.

As shown, the device 1100 includes a processor 1110, a memory 1120 coupled to the processor 1110, a suitable transmitter (TX) and receiver (RX) 1140 coupled to the processor 1110, and a communication interface coupled to the TX/RX 1140. The memory 1110 stores at least a part of a program 1130. The TX/RX 1140 is for bidirectional communications. The TX/RX 1140 has at least one antenna to facilitate communication, though in practice an Access Node mentioned in this application may have several ones. The communication interface may represent any interface that is necessary for communication with other network elements, such as X2 interface for bidirectional communications between eNBs, S1 interface for communication between a Mobility Management Entity (MME)/Serving Gateway (S-GW) and the eNB, Un interface for communication between the eNB and a relay node (RN), or Uu interface for communication between the eNB and a terminal device.

The program 1130 is assumed to include program instructions that, when executed by the associated processor 1110, enable the device 1100 to operate in accordance with the embodiments of the present disclosure, as discussed herein with reference to FIGS. 2A, 2B, 3, 6A, 6B, 7, 9 and 10. The embodiments herein may be implemented by computer software executable by the processor 1110 of the device 1100, or by hardware, or by a combination of software and hardware. The processor 1110 may be configured to implement various embodiments of the present disclosure. Furthermore, a combination of the processor 1110 and memory 1110 may form processing means 1150 adapted to implement various embodiments of the present disclosure.

The memory 1110 may be of any type suitable to the local technical network and may be implemented using any suitable data storage technology, such as a non-transitory computer readable storage medium, semiconductor-based memory devices, magnetic memory devices and systems, optical memory devices and systems, fixed memory and removable memory, as non-limiting examples. While only one memory 1110 is shown in the device 1100, there may be several physically distinct memory modules in the device 1100. The processor 1110 may be of any type suitable to the local technical network, and may include one or more of general purpose computers, special purpose computers, microprocessors, digital signal processors (DSPs) and processors based on multicore processor architecture, as non-limiting examples. The device 1100 may have multiple processors, such as an application specific integrated circuit chip that is slaved in time to a clock which synchronizes the main processor.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 2A, 2B, 3, 6A, 6B, 7, 9 and 10. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1.-23. (canceled)

24. A method of a terminal device comprising:
receiving, from a master node, a first indication to deactivate a cell group associated with a secondary node; and
triggering, upon reception of the first indication, a packet data convergence protocol (PDCP) entity of a signaling radio bearer 3 (SRB3) between the secondary node and the terminal device to perform service data unit (SDU) discard.

25. The method of claim 24, further comprising:
re-establishing a first radio link control (RLC) entity of the SRB3.

26. The method of claim 24, wherein:
the PDCP entity discards PDCP service data units (SDUs) and PDCP protocol data units (PDUs).

27. The method of claim 24, further comprising:
resetting a media access control (MAC) for the cell group.

28. The method of claim 24, wherein
the first indication is comprised in a radio resource control (RRC) reconfiguration message.

29. The method of claim 24, wherein
the master node requests the secondary node to deactivate the cell group

30. The method of claim 24, wherein
the secondary node requests the master node to deactivate the cell group.

31. The method of claim 24, further comprising:
deactivating a primary cell of the cell group and secondary cells of the cell group.

32. The method of claim 24, further comprising:
receiving a message to activate the cell group of the second network device; and
initiating a random access procedure on a primary cell of the cell group.

33. The method of claim 32, wherein
the master node requests the secondary node to activate the cell group

34. The method of claim 32, wherein
the secondary node requests the master node to activate the cell group.

35. A terminal device comprising:
one or more memories storing instructions; and
one or more processors configured to execute the instructions to:
receive, from a master node, a first indication to deactivate a cell group associated with a secondary node; and
trigger, upon reception of the first indication, a packet data convergence protocol (PDCP) entity of a signaling radio bearer 3 (SRB3) between the secondary node and the terminal device to perform service data unit (SDU) discard.

36. The terminal device of claim 35, wherein
the terminal re-establishes a first radio link control (RLC) entity of the SRB3.

37. The terminal device of claim 35, wherein:
the PDCP entity discards PDCP service data units (SDUs) and PDCP protocol data units (PDUs).

38. The terminal device of claim 35, wherein
the terminal resets a media access control (MAC) for the cell group.

39. The terminal device of claim 35, wherein
the first indication is comprised in a radio resource control (RRC) reconfiguration message.

40. The terminal device of claim 35, wherein
the secondary node requests the master node to deactivate the cell group.

41. The terminal device of claim 35, wherein
the master node requests the secondary node to deactivate the cell group

42. The terminal device of claim 35, wherein
the terminal deactivates a primary cell of the cell group and secondary cells of the cell group.

43. The terminal device of claim 35, wherein
the terminal receives a message to activate the cell group of the second network device; and
initiates a random access procedure on a primary cell of the cell group.
